(19) United States
(12) Patent Application Publication
(10) Pub. No.: US 2026/0228631 A1
(43) Pub. Date: Aug. 6, 2026

(54) SYSTEMS AND METHODS FOR META-LEARNING IN FEDERATED LEARNING NETWORKS

(71) Applicant: Samsung Electronics Co., Ltd., Gyeonggi-do (KR)

(72) Inventors: Mohammad Vahid JAMALI, Nashville, TN (US); Hamid SABER, San Diego, CA (US); Jung Hyun BAE, San Diego, CA (US)

(21) Appl. No.: 19/459,642

(22) Filed: Jan. 26, 2026

Related U.S. Application Data
(60) Provisional application No. 63/753,691, filed on Feb. 4, 2025.

(51) Int. Cl. G06N 20/00

(52) U.S. Cl. CPC G06N 20/00

(57) ABSTRACT

A method of federated learning performed by a server and a plurality of client devices is provided. The method includes: receiving, at each client device, a global model comprising a set of model parameters maintained by the server; performing, at each client device, a plurality of local fine-tuning steps on the global model using local training data of the client device to generate a personalized model for the client device; computing, at each client device, update information based on the personalized model after the plurality of local fine-tuning steps; transmitting, from each client device to the server, the update information; and updating, at the server, the global model based on the update information received from the client devices, wherein the updating is based at least in part on a loss of the personalized models evaluated after the plurality of local fine-tuning steps.

### CROSS-REFERENCE TO RELATED APPLICATION

This application claims the priority benefit under 35 U.S.C. § 119 (e) of U.S. Provisional Application No. 63/753,691, filed on Feb. 4, 2025, the disclosure of which is incorporated by reference in its entirety as if fully set forth herein.

### TECHNICAL FIELD

The disclosure relates to federated learning in distributed computing environments. More particularly, the subject matter disclosed herein relates to improvements to meta-learning techniques for updating global models in federated learning systems.

### SUMMARY

Machine learning models are increasingly trained in distributed environments, such as federated learning systems, where multiple client devices collaboratively update a shared global model without transferring their local data. In such systems, client devices often perform local training steps on the global model to improve personalization, and the server aggregates client-provided updates to refine the global model across communication rounds. A communication round may refer to a cycle in which information related to a shared model is exchanged between a server and one or more client devices.

To address challenges associated with coordinating learning across many distributed client devices, prior approaches have used federated averaging or related aggregation techniques in which each client performs a limited number of local updates and the server combines the client updates to form a new global model. Some techniques attempt to incorporate personalization by allowing clients to fine-tune the global model using local data, while others explore meta-learning concepts that adjust the global model based on how well it adapts to individual clients.

One issue with the above approaches is that they generally do not account for the effects of multiple local fine-tuning steps when computing the server-side update, resulting in suboptimal personalization across heterogeneous client populations. Additionally, meta-learning techniques often require second-order derivative calculations, which are computationally expensive and impractical for client devices with limited processing capability.

To overcome these issues, systems and methods are described herein for updating a global model based on a loss evaluated after multiple local fine-tuning steps at client devices and for computing meta-gradient information using efficient, Hessian-free first-order approximations. The disclosed techniques enable the server to incorporate post-adaptation performance directly into the global update while allowing client devices to compute update information without the overhead of second-order derivatives.

The above approaches improve on previous methods because they provide more effective personalization for heterogeneous clients, reduce computational burden during meta-learning, and enable scalable, communication-efficient training across large federated networks. As a result, the disclosed systems and methods achieve improved global model performance and faster convergence relative to conventional federated learning techniques.

In an embodiment, a method of federated learning performed by a server and a plurality of client devices comprises: receiving, at each client device, a global model comprising a set of model parameters maintained by the server; performing, at each client device, a plurality of local fine-tuning steps on the global model using local training data of the client device to generate a personalized model for the client device; computing, at each client device, update information based on the personalized model after the plurality of local fine-tuning steps; transmitting, from each client device to the server, the update information; and updating, at the server, the global model based on the update information received from the client devices, wherein the updating is based at least in part on a loss of the personalized models evaluated after the plurality of local fine-tuning steps.

In an embodiment, a method of federated learning performed by a server and a plurality of client devices comprises: receiving, at each client device, a global model comprising a set of model parameters maintained by the server; performing, at each client device, a plurality of local fine-tuning steps on the global model using local training data of the client device to generate a personalized model for the client device; computing, at each client device, update information based on the personalized model using a first-order approximation that avoids computation of second-order derivatives; transmitting, from each client device to the server, the update information; and updating, at the server, the global model based on the update information received from the client devices, wherein the update information is computed using a Hessian-free approximation of a meta-gradient associated with the personalized model after the plurality of local fine-tuning steps.

In an embodiment, a system comprises a server configured to maintain a global model comprising a set of model parameters; and a plurality of client devices, each client device configured to: receive the global model from the server; perform a plurality of local fine-tuning steps on the global model using local training data of the client device to generate a personalized model; and compute update information based on the personalized model after the plurality of local fine-tuning steps, wherein the plurality of client devices are further configured to transmit the update information to the server, and wherein the server is further configured to update the global model based on the update information received from the plurality of client devices, the updating being based at least in part on a loss of the personalized models evaluated after the plurality of local fine-tuning steps.

### BRIEF DESCRIPTION OF THE DRAWINGS

In the following section, the aspects of the subject matter disclosed herein will be described with reference to exemplary embodiments illustrated in the figures, in which:

FIG. 1 is a block diagram illustrating a federated learning system including a server and a plurality of client devices configured to exchange global model parameters and update information, according to an embodiment;

FIG. 2 is a flowchart illustrating a method for updating a global model based on loss values of personalized models after multiple local fine-tuning steps performed at client devices, according to an embodiment;

FIG. 3 is a flowchart illustrating a method for computing update information using a first-order, Hessian-free approximation of a meta-gradient in a federated learning system, according to an embodiment; and

FIG. 4 is a block diagram of an electronic device in a network environment, according to an embodiment.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

“Federated learning” as used herein may refer to a distributed machine learning process in which multiple client devices collaboratively train a shared model without exchanging their local data. Some examples of “federated learning” may include training conducted across mobile devices that keep data on-device, and distributed learning across IoT sensors without centralized data collection. “Global model” as used herein may refer to a machine learning model maintained by a server and updated based on information received from multiple client devices. Some examples of “global model” may include a neural network shared among participating clients, and a parameterized prediction model broadcast to clients during each training round. “Model parameters” as used herein may refer to numerical values defining the behavior of a machine learning model and updated during training. Some examples of “model parameters” may include weight vectors of a neural network layer, and bias terms associated with the model's prediction functions. “Local fine-tuning steps” as used herein may refer to one or more optimization updates performed by a client device on the received global model using the client's own local data. Some examples of “local fine-tuning steps” may include gradient-based updates performed over local mini-batches, and sequential adaptation steps executed during a training round before computing update information.

“Local training data” as used herein may refer to data stored on or collected by a client device and used to perform local training or fine-tuning of a received global model. Some examples of “local training data” may include user-generated application data such as images or text, and sensor or measurements made by and unique to the client device. “Personalized model” as used herein may refer to a version of the global model that has been adapted or fine-tuned using the local training data of a particular client device. Some examples of “personalized model” may include a neural network adjusted through multiple local gradient steps, and a task-specific model variant optimized for a single client's data distribution. “Update information” as used herein may refer to information computed by a client device and provided to the server for updating the global model. Some examples of “update information” may include parameter differences or gradients computed after local fine-tuning, and approximations of meta-gradient contributions used to guide server-side model updates. “Loss of the personalized models” as used herein may refer to a measure of prediction error or objective value of a personalized model evaluated on the client's local training data. Some examples of “loss of the personalized models” may include a cross-entropy loss computed after the final fine-tuning step, and a regression or classification error used to quantify post-adaptation model performance.

“Gradient-based updates” as used herein may refer to optimization steps in which model parameters are adjusted in a direction determined by one or more gradients of a loss function. Some examples of “gradient-based updates” may include applying a stochastic gradient descent step over a local mini-batch, and performing an update using an adaptive optimizer such as Adam or RMSProp based on computed gradients. “Gradient of the loss of the personalized model” as used herein may refer to a derivative of a loss function with respect to the parameters of a personalized model obtained after local fine-tuning. Some examples of “gradient of the loss of the personalized model” may include a gradient ∇fᵢ (\tilde{w}ᵢ) computed at the final adapted model on a local batch of data, and a gradient used to form a first-order or meta-update returned by the client device to the server. “Difference between the personalized model and the global model” as used herein may refer to a vector or set of values representing the change in model parameters resulting from local fine-tuning relative to the parameters originally received from the server. Some examples of “difference between the personalized model and the global model” may include a parameter delta vector \tilde{w}ᵢ-wₖ, and a residual update indicating how local adaptation modified the global model for a given client. “Weighted average” as used herein may refer to an aggregation operation in which contributions from multiple client devices are combined according to respective weights assigned to each contribution. Some examples of “weighted average” may include averaging client updates proportional to each client's number of training samples, and aggregating updates based on post-adaptation loss values to emphasize clients with higher or lower losses.

“Non-identically distributed training data” as used herein may refer to training data stored on different client devices that follow different statistical distributions or represent different underlying tasks or user behaviors. Some examples of “non-identically distributed training data” may include user-specific text or image data that varies across devices, and sensor or application data whose characteristics differ from one client device to another. “Objective function” as used herein may refer to a mathematical function that quantifies model performance and is used to guide parameter updates during training. Some examples of “objective function” may include a loss function evaluated on adapted client models to determine server-side updates, and a meta-learning objective that aggregates post-adaptation losses across participating client devices. “Computation capability of a client device” as used herein may refer to the hardware or software resources available on a client device for performing local training or fine-tuning operations. Some examples of “computation capability of a client device” may include available processing power or memory capacity, and the ability of the device to execute multiple gradient-based update steps within a training round. “Communication latency constraint” as used herein may refer to limitations on the amount of time or bandwidth available for transmitting information between a server and a client device during a training round. Some examples of “communication latency constraint” may include delays caused by low-bandwidth or unstable network connections, and limitations on how frequently a device can upload update information due to energy or connectivity restrictions.

“First-order approximation” as used herein may refer to an approximation technique that computes update information using only first-order gradient terms without evaluating or estimating second-order derivatives. Some examples of “first-order approximation” may include computing a meta-update based solely on the gradient of the loss at a personalized model, and forming an update rule that ignores curvature information associated with the Hessian. “Second-order derivatives” as used herein may refer to derivatives of a loss function with respect to model parameters that quantify curvature or how gradients change with respect to parameter variations. Some examples of “second-order derivatives” may include elements of a Hessian matrix ∂²f/∂wᵢ∂wⱼ, and Hessian vector products used in exact meta-gradient computation. “Hessian-free approximation of a meta-gradient” as used herein may refer to a technique for estimating the meta-gradient without computing or storing a Hessian matrix. Some examples of “Hessian-free approximation of a meta-gradient” may include approximating a Hessian vector product using a finite-difference expression involving perturbed gradients, and updating a meta-gradient estimate by processing previously computed gradients in reverse order without forming a Hessian. “Meta-gradient” as used herein may refer to gradient information that reflects how updates to a global model influence performance of personalized models after one or more local fine-tuning steps. Some example of “meta-gradient” may include a gradient of a post-adaptation loss with respect to global model parameters, and an approximation of such a gradient computed using first-order or Hessian-free techniques. “Second-order dependency” as used herein may refer to a relationship in which an update depends on curvature information or on the effect of parameter changes on the gradients themselves. Some examples of “second-order dependency” may include the influence of earlier fine-tuning steps on later gradients through a Hessian term, and the need to account for how the adapted model depends on the original global model via second-order derivative relationships.

The systems and methods disclosed herein relate to improving federated learning by updating a global model based on performance measured after multiple local fine-tuning steps at client devices. In one embodiment, each client device may receive a global model from a server, perform a sequence of local fine-tuning steps using locally available training data, and compute update information based on the resulting personalized model. The server may aggregate the update information from multiple client devices and update the global model using a loss or performance measure evaluated after the plurality of local fine-tuning steps, thereby enabling improved personalization across heterogeneous clients while maintaining scalability.

In another embodiment, the present disclosure provides techniques for efficiently computing update information using first-order, Hessian-free approximations of meta-gradients, allowing client devices to participate in meta-learning without the computational overhead of second-order derivative calculations. A corresponding system embodiment includes a server and multiple client devices configured to perform the above operations in a distributed learning environment. These approaches achieve improved global model performance, faster convergence, and reduced computational complexity relative to conventional federated learning methods.

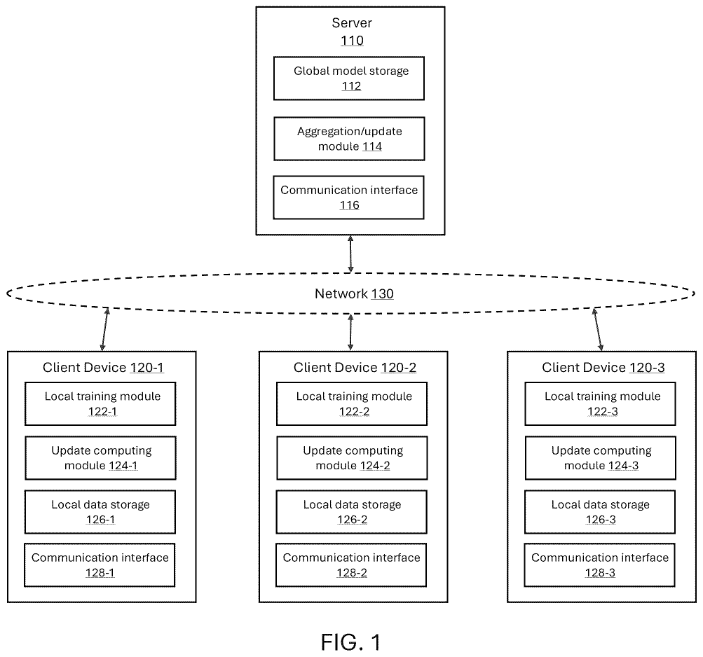

FIG. 1 illustrates an example federated learning system including a server 110 and a plurality of client devices 120-1, 120-2, and 120-3 that communicate with one another through a network 130, according to an embodiment. Although three client devices are shown for illustrative clarity, more or fewer client devices may be included. In various embodiments, the system may support tens, hundreds, or thousands of participating client devices operating concurrently or intermittently.

The server 110 may be implemented using any suitable computing platform capable of maintaining and updating a global machine learning model. Examples include a cloud computing server, a datacenter server node, a distributed computing cluster, or a virtual machine instance executing within a cloud infrastructure. The server may include one or more processors, memory components, and network interfaces.

As shown in FIG. 1, the server 110 may include a global model storage 112, an aggregation/update module 114, and a communication interface 116. The global model storage 112 may store model parameters associated with a global machine learning model distributed to the client devices. The aggregation/update module 114 may update the global model based on update information received from the client devices, and may apply any suitable update rule, such as weighted averaging, gradient-based optimization, meta-learning update rules, or loss-based update criteria. The communication interface 116 may include wired or wireless transceivers, network interface controllers, or other communication circuitry that enables communication across the network 130. In operation, the communication interface 116 enables the server 110 to distribute the global model to the client devices and to receive update information therefrom.

Each client device 120-1, 120-2, and 120-3 may correspond to any electronic device capable of performing local computations and communicating with the server 110. Examples include smartphones, laptop computers, tablets, wearable devices, home assistant devices, Internet-of-Things (IoT) devices, embedded processors, industrial sensors, and vehicle-based computing systems. The client devices may be heterogeneous, with varying computational capabilities, memory capacities, and network performance characteristics.

Each client device may include a local training module 122-1, 122-2, 122-3 configured to perform a plurality of local fine-tuning steps on the global model using locally stored training data. An update computing module 124-1, 124-2, 124-3 may compute update information based on a personalized model obtained after the local fine-tuning steps. A local data storage 126-1, 126-2, 126-3 may store training examples, intermediate results, model checkpoints, or privacy-preserving data representations. The communication interface 128-1, 128-2, 128-3 may include any suitable communication module (e.g., Wi-Fi, Bluetooth, cellular, Ethernet) used to exchange information with the server 110.

During operation, the server 110 may transmit various types of information to the client devices 120-1, 120-2, and 120-3. Examples may include global model parameters, updated model versions, hyperparameters such as learning rates and the number of local steps, task configuration settings, model-layer selection instructions, or general participation instructions for a training round.

In response, each client device may transmit update information derived from the locally fine-tuned model. Such information may include parameter differences relative to the received global model, gradient values evaluated after local adaptation, post-adaptation loss values, approximate meta-gradients, first-order gradient combinations, or any other update information consistent with the training algorithm. Additional information such as device capability metrics or training statistics may also be transmitted in some embodiments.

The network 130 may include any wired or wireless network suitable for exchanging information between the server 110 and the client devices 120-1, 120-2, and 120-3. Examples include Wi-Fi networks, cellular networks (e.g., 3G, 4G, 5G, 6G), Ethernet networks, fiber-optic networks, wide-area networks (WANs), local-area networks (LANs), mesh networks, Bluetooth or short-range communication networks, and the Internet. The system may operate across one or more network types simultaneously. It will be appreciated that FIG. 1 illustrates only one example configuration, and other system architectures may be used.

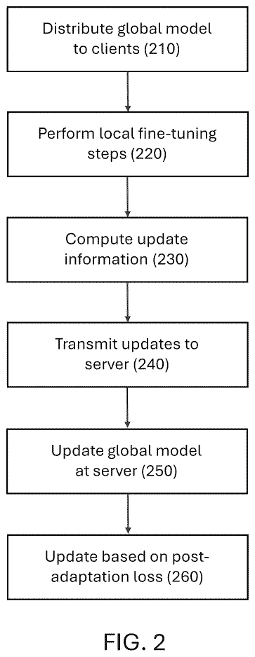

The system components described above with respect to FIG. 1 may be used to carry out a federated learning or federated meta-learning procedure. FIG. 2 introduces an example method performed collaboratively by the server and the plurality of client devices, in which the server distributes a global model, the client devices perform local fine-tuning and compute update information, and the server updates the global model based on the information returned from the clients. The steps of FIG. 2 are described in greater detail below, including the mathematical operations executed within the client devices and the server during the learning process.

FIG. 2 is a flowchart illustrating a method for updating a global model based on loss values of personalized models after multiple local fine-tuning steps performed at client devices, according to an embodiment.

At step 210, for a given server round k, the server may select a subset of client devices Aₖ, for example of size rN where r represents the fraction of active users. The server may transmit the current global model parameters wₖ to all client devices in the selected subset. The transmitted information may include the parameter vector wₖ, a number of local fine-tuning steps v, a number of meta-local-update steps τ, and one or more hyperparameters such as a learning rate α. Each receiving client may initialize its local model according to Equation (1).

$${w}_{0}^{i} ← {w}_{k} \qquad ( 1 )$$

At step 220, each client may perform v fine-tuning steps on the received global model using its own local data. For client i, and for iterations l=1 . . . v, a gradient-based update may be performed as shown in Equation (2):

$${\tilde{w}}_{l}^{i} = {\tilde{w}}_{i - 1}^{i} - α ∇ {f}_{i} ( {\tilde{w}}_{i - 1}^{i} , {D}_{i , l - 1} ) , \qquad ( 2 )$$

where ƒᵢ (⋅) is the local loss function for client i, D_{i,l-1} denotes a mini-batch of local training examples, and

$${\tilde{w}}_{0}^{i} = {w}_{k} .$$

The final adapted model after v steps may be

$${\tilde{w}}_{v}^{i} .$$

Intermediate adapted states

$${\tilde{w}}_{l}^{i}$$

may be retained for later computation of meta-gradient information.

At step 230, each client may compute update information derived from the adapted model and its contribution to the meta-learning objective. The client begins by computing a post-adaptation gradient as shown in Equation (3).

$$d ← ∇ {f}_{i} ( {\tilde{w}}_{v}^{i} , {D}_{i , v} ) \qquad ( 3 )$$

Next, for each fine-tuning step l′=1 . . . v, the client may estimate a second-order term as shown in Equation (4):

$${\hat{∇}}^{2} {f}_{i} ( {\tilde{w}}_{v - {l}^{′}}^{i} , {D}_{i , v - {l}^{′}}^{′} ) , \qquad ( 4 )$$

and apply Equation (5):

$$d ← ( I - α {\hat{∇}}^{2} {f}_{i} ( {\tilde{w}}_{v - {l}^{′}}^{i} , {D}_{i , v - {l}^{′}}^{′} ) ) d , \qquad ( 5 )$$

which reconstructs the exact meta-gradient corresponding to the influence of the global model wₖ on the adapted model

$${\tilde{w}}_{v}^{i} .$$

The final client-side update vector may be computed as shown in Equation (6):

$${w}_{out}^{i} = {\tilde{w}}_{v}^{i} - β d , \qquad ( 6 )$$

where β is a local learning rate for the meta-update. The value

$${w}_{out}^{i}$$

constitutes the update information transmitted to the server.

At step 240, each client device may return its update information, including the updated local model

$${w}_{out}^{i} ,$$

to the server. Additional metadata, such as client sample counts or local loss statistics, may also be provided in some embodiments.

At step 250, the server may aggregate the received client-side updated models to generate a new global model. In one embodiment, the server may compute Equation (7):

$${w}_{k + 1} = \frac{1}{\vert {A}_{k} \vert} {\sum }_{i ∈ {A}_{k}} {w}_{out}^{i} , \qquad ( 7 )$$

thereby producing an updated global model that reflects the personalized adaptation and meta-gradient contributions of the participating clients.

At step 260, the server may further refine the global model based on post-adaptation loss values associated with the adapted models.

$${\tilde{w}}_{v}^{i} .$$

In certain embodiments, the meta-objective optimized by the server may include terms of the form of Equation (8):

$${\sum }_{i ∈ {A}_{k}} {f}_{i} ( {\tilde{w}}_{v}^{i} ) , \qquad ( 8 )$$

which encourages the global model to improve its ability to adapt efficiently to heterogenous client distributions during subsequent rounds. This enables improved personalization and convergence behavior relative to conventional federated learning algorithms. A meta-objective may refer to an objective function evaluated at the server that measures performance of personalized models after local fine-tuning and is used to guide updates to the global model across communication rounds.

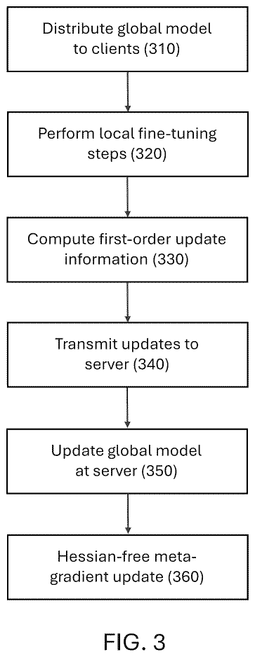

As described above with respect to FIG. 2, the server and client devices may perform a meta-learning procedure in which each client executes multiple local fine-tuning steps and computes update information that incorporates second-order dependencies arising from the local adaptation process. In some embodiments, however, computing or estimating second-order derivative terms may be computationally expensive for certain client devices, particularly those with limited processing or memory resources. FIG. 3 illustrates an alternative method that may be performed in place of the method of FIG. 2, in which each client computes update information using a first-order, Hessian-free approximation of the meta-gradient. This approach reduces computational overhead at the client devices while preserving the overall structure of the federated meta-learning process.

FIG. 3 is a flowchart illustrating a method for computing update information using a first-order, Hessian-free approximation of a meta-gradient in a federated learning system, according to an embodiment.

At step 310, the server may select a subset of client devices Aₖ for participation in round k and transmits the current global model parameters wₖ. The transmitted information may include: the parameter vector wₖ, a number of local fine-tuning steps v, a learning rate α, and, in certain embodiments, a perturbation value δ used for Hessian-free finite-difference updates, where the perturbation value δ defines a magnitude of a parameter perturbation applied when estimating gradient-related terms without computing second-order derivatives.

Each client may initialize its local model as shown in Equation (9).

$${\tilde{w}}_{0}^{i} ← {w}_{k} \qquad ( 9 )$$

At step 320, each client may perform v iterations of local gradient-based adaptation using its own training batches {D_{i,1}}. For client i, and for each l=1 . . . v, the update may be expressed as Equation (10):

$${\tilde{w}}_{l}^{i} = {\tilde{w}}_{l - 1}^{i} - α ∇ {f}_{i} ( {\tilde{w}}_{l - 1}^{i} , {D}_{i , l - 1} ) , \qquad ( 10 )$$

where ƒᵢ(.) is the local loss function associated with client i.

After v iterations, the client may obtain an adapted model

$${\tilde{w}}_{v}^{i} .$$

This adapted model is used to compute meta-update information in step 330.

At step 330, each client may compute update information derived from the adapted model

$${\tilde{w}}_{v}^{i} .$$

Two example embodiments are described below: a first-order embodiment and a Hessian-free embodiment.

In a first-order embodiment, the client may compute a gradient at the adapted model and return an update of the form of Equation (11):

$${w}_{out}^{i} = {w}_{i n}^{i} - β ∇ {f}_{i} ( {\tilde{w}}_{v}^{i} , {D}_{i , v} ) , \qquad ( 11 )$$

$$where {w}_{i n}^{i} = {w}_{k}$$

and β is a meta-learning rate.

This embodiment avoids any second-order terms and significantly reduces computational load relative to exact meta-gradient computation.

In another embodiment, the client may obtain a meta-gradient approximation using finite-difference estimates rather than explicit Hessian computation. The client may initialize Equation (12):

$$d ← ∇ {f}_{i} ( {\tilde{w}}_{v}^{i} , {D}_{i , v} ) , \qquad ( 12 )$$

and then process the local fine-tuning steps in reverse order. For each l′=1 . . . v, the client may compute two perturbed gradients of Equations (13) and (14):

$${g}_{{l}^{′}}^{+} = ∇ {f}_{i} ( {\tilde{w}}_{v - {l}^{′}}^{i} + δ d , {D}_{i , v - {l}^{′}}^{′} ) \qquad ( 13 )$$

$${g}_{{l}^{′}}^{-} = ∇ {f}_{i} ( {\tilde{w}}_{v - {l}^{′}}^{i} - δ d , {D}_{i , v - {l}^{′}}^{′} ) , \qquad ( 14 )$$

and update the vector d using a finite-difference Hessian-vector approximation of Equation (15):

$$d ← d - \frac{α}{2 δ} ( {g}_{{l}^{′}}^{+} - {g}_{{l}^{′}}^{-} ) . \qquad ( 15 )$$

The resulting vector d may serve as an efficient approximation of the contribution of the global model to the adapted model.

The final update returned to the server may be shown in Equation (16).

$${w}_{out}^{i} = {w}_{i n}^{i} - β d \qquad ( 16 )$$

At step 340, each client may transmit its update

$${w}_{out}^{i}$$

to the server. In the first-order embodiment, the update may comprise a gradient taken at the adapted model. In the Hessian-free embodiment, the update may include the meta-gradient approximation computed using the finite-difference procedure described above. Clients may optionally provide additional metadata such as sample counts, loss values, or confidence measures.

At step 350, the server may aggregate the updates from participating client devices to produce a new global model. For example, the server may compute Equation (17).

$${w}_{k + 1} = \frac{1}{\vert {A}_{k} \vert} {\sum }_{i ∈ {A}_{k}} {w}_{out}^{i} \qquad ( 17 )$$

This aggregation incorporates contributions from clients regardless of whether they use first-order or Hessian-free approximations.

At step 360, the server may optionally apply additional refinement based on the post-adaptation performance of the client models. For instance, the server may evaluate or approximate a meta-objective of the form shown in Equation (18):

$${\sum }_{i ∈ {A}_{k}} {f}_{i} ( {\tilde{w}}_{v}^{i} ) , \qquad ( 18 )$$

and adjust the global model to improve its adaptability to heterogeneous client distributions. In embodiments implementing Hessian-free updates, the approximations provided by the clients may be used to guide this refinement without requiring the server to compute second-order derivatives directly.

The methods described with respect to FIGS. 2 and 3 may be implemented independently or in combination within the federated learning system of FIG. 1. FIG. 2 illustrates an embodiment in which each client device computes update information using a procedure that incorporates second-order dependencies arising from multiple local fine-tuning steps, enabling exact or near-exact meta-gradient computation. FIG. 3 illustrates an alternative embodiment in which each client device computes update information using a reduced-complexity first-order or Hessian-free approximation that avoids explicit second-order derivative calculations. Either approach may be used depending on the computational capabilities of the client devices and the desired balance between accuracy and efficiency. The disclosed techniques therefore provide a flexible framework for performing personalized federated meta-learning across heterogeneous client populations while reducing communication and computation overhead where appropriate.

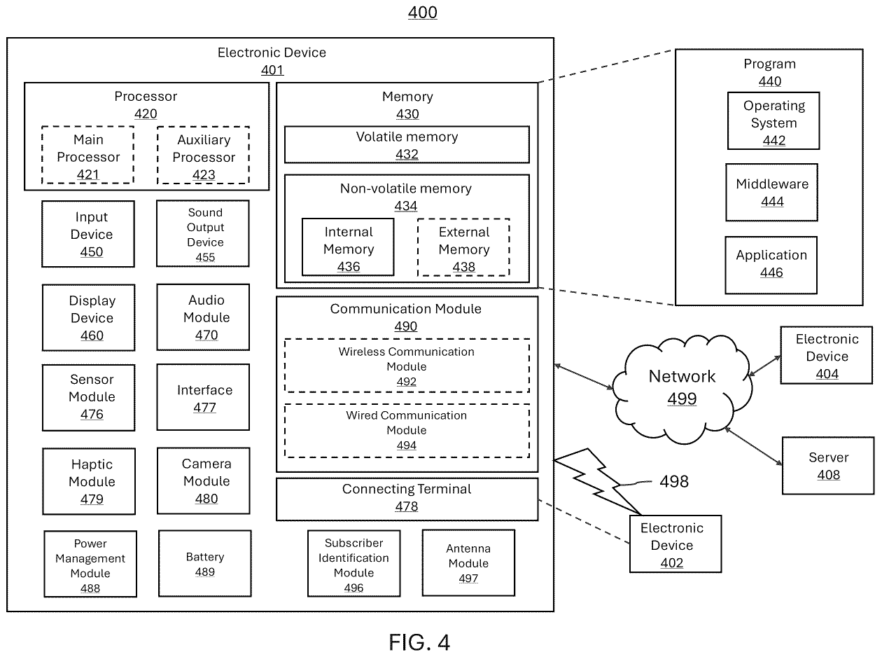

FIG. 4 is a block diagram of an electronic device in a network environment 400, according to an embodiment.

Referring to FIG. 4, an electronic device 401 in a network environment 400 may communicate with an electronic device 402 via a first network 498 (e.g., a short-range wireless communication network), or an electronic device 404 or a server 408 via a second network 499 (e.g., a long-range wireless communication network). The electronic device 401 may communicate with the electronic device 404 via the server 408. The electronic device 401 may include a processor 420, a memory 430, an input device 450, a sound output device 455, a display device 460, an audio module 470, a sensor module 476, an interface 477, a haptic module 479, a camera module 480, a power management module 488, a battery 489, a communication module 490, a subscriber identification module (SIM) card 496, or an antenna module 497. In one embodiment, at least one (e.g., the display device 460 or the camera module 480) of the components may be omitted from the electronic device 401, or one or more other components may be added to the electronic device 401. Some of the components may be implemented as a single integrated circuit (IC). For example, the sensor module 476 (e.g., a fingerprint sensor, an iris sensor, or an illuminance sensor) may be embedded in the display device 460 (e.g., a display).

The processor 420 may execute software (e.g., a program 440) to control at least one other component (e.g., a hardware or a software component) of the electronic device 401 coupled with the processor 420 and may perform various data processing or computations.

As at least part of the data processing or computations, the processor 420 may load a command or data received from another component (e.g., the sensor module 476 or the communication module 490) in volatile memory 432, process the command or the data stored in the volatile memory 432, and store resulting data in non-volatile memory 434. The processor 420 may include a main processor 421 (e.g., a central processing unit (CPU) or an application processor (AP)), and an auxiliary processor 423 (e.g., a graphics processing unit (GPU), an image signal processor (ISP), a sensor hub processor, or a communication processor (CP)) that is operable independently from, or in conjunction with, the main processor 421. Additionally or alternatively, the auxiliary processor 423 may be adapted to consume less power than the main processor 421, or execute a particular function. The auxiliary processor 423 may be implemented as being separate from, or a part of, the main processor 421.

The auxiliary processor 423 may control at least some of the functions or states related to at least one component (e.g., the display device 460, the sensor module 476, or the communication module 490) among the components of the electronic device 401, instead of the main processor 421 while the main processor 421 is in an inactive (e.g., sleep) state, or together with the main processor 421 while the main processor 421 is in an active state (e.g., executing an application). The auxiliary processor 423 (e.g., an image signal processor or a communication processor) may be implemented as part of another component (e.g., the camera module 480 or the communication module 490) functionally related to the auxiliary processor 423.

The memory 430 may store various data used by at least one component (e.g., the processor 420 or the sensor module 476) of the electronic device 401. The various data may include, for example, software (e.g., the program 440) and input data or output data for a command related thereto. The memory 430 may include the volatile memory 432 or the non-volatile memory 434. Non-volatile memory 434 may include internal memory 436 and/or external memory 438.

The program 440 may be stored in the memory 430 as software, and may include, for example, an operating system (OS) 442, middleware 444, or an application 446.

The input device 450 may receive a command or data to be used by another component (e.g., the processor 420) of the electronic device 401, from the outside (e.g., a user) of the electronic device 401. The input device 450 may include, for example, a microphone, a mouse, or a keyboard.

The sound output device 455 may output sound signals to the outside of the electronic device 401. The sound output device 455 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 460 may visually provide information to the outside (e.g., a user) of the electronic device 401. The display device 460 may include, for example, a display, a hologram device, or a projector and control circuitry to control a corresponding one of the display, hologram device, and projector. The display device 460 may include touch circuitry adapted to detect a touch, or sensor circuitry (e.g., a pressure sensor) adapted to measure the intensity of force incurred by the touch.

The audio module 470 may convert a sound into an electrical signal and vice versa. The audio module 470 may obtain the sound via the input device 450 or output the sound via the sound output device 455 or a headphone of an external electronic device 402 directly (e.g., wired) or wirelessly coupled with the electronic device 401.

The sensor module 476 may detect an operational state (e.g., power or temperature) of the electronic device 401 or an environmental state (e.g., a state of a user) external to the electronic device 401, and then generate an electrical signal or data value corresponding to the detected state. The sensor module 476 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 477 may support one or more specified protocols to be used for the electronic device 401 to be coupled with the external electronic device 402 directly (e.g., wired) or wirelessly. The interface 477 may include, for example, a high-definition multimedia interface (HDMI), a universal serial bus (USB) interface, a secure digital (SD) card interface, or an audio interface.

A connecting terminal 478 may include a connector via which the electronic device 401 may be physically connected with the external electronic device 402. The connecting terminal 478 may include, for example, an HDMI connector, a USB connector, an SD card connector, or an audio connector (e.g., a headphone connector).

The haptic module 479 may convert an electrical signal into a mechanical stimulus (e.g., a vibration or a movement) or an electrical stimulus which may be recognized by a user via tactile sensation or kinesthetic sensation. The haptic module 479 may include, for example, a motor, a piezoelectric element, or an electrical stimulator.

The camera module 480 may capture a still image or moving images. The camera module 480 may include one or more lenses, image sensors, image signal processors, or flashes. The power management module 488 may manage power supplied to the electronic device 401. The power management module 488 may be implemented as at least part of, for example, a power management integrated circuit (PMIC).

The battery 489 may supply power to at least one component of the electronic device 401. The battery 489 may include, for example, a primary cell which is not rechargeable, a secondary cell which is rechargeable, or a fuel cell.

The communication module 490 may support establishing a direct (e.g., wired) communication channel or a wireless communication channel between the electronic device 401 and the external electronic device (e.g., the electronic device 402, the electronic device 404, or the server 408) and performing communication via the established communication channel. The communication module 490 may include one or more communication processors that are operable independently from the processor 420 (e.g., the AP) and supports a direct (e.g., wired) communication or a wireless communication. The communication module 490 may include a wireless communication module 492 (e.g., a cellular communication module, a short-range wireless communication module, or a global navigation satellite system (GNSS) communication module) or a wired communication module 494 (e.g., a local area network (LAN) communication module or a power line communication (PLC) module). A corresponding one of these communication modules may communicate with the external electronic device via the first network 498 (e.g., a short-range communication network, such as BLUETOOTH™, wireless-fidelity (Wi-Fi) direct, or a standard of the Infrared Data Association (IrDA)) or the second network 499 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 492 may identify and authenticate the electronic device 401 in a communication network, such as the first network 498 or the second network 499, using subscriber information (e.g., international mobile subscriber identity (IMSI)) stored in the subscriber identification module 496.

The antenna module 497 may transmit or receive a signal or power to or from the outside (e.g., the external electronic device) of the electronic device 401. The antenna module 497 may include one or more antennas, and, therefrom, at least one antenna appropriate for a communication scheme used in the communication network, such as the first network 498 or the second network 499, may be selected, for example, by the communication module 490 (e.g., the wireless communication module 492). The signal or the power may then be transmitted or received between the communication module 490 and the external electronic device via the selected at least one antenna.

Commands or data may be transmitted or received between the electronic device 401 and the external electronic device 404 via the server 408 coupled with the second network 499. Each of the electronic devices 402 and 404 may be a device of a same type as, or a different type, from the electronic device 401. All or some of operations to be executed at the electronic device 401 may be executed at one or more of the external electronic devices 402, 404, or 408. For example, if the electronic device 401 should perform a function or a service automatically, or in response to a request from a user or another device, the electronic device 401, instead of, or in addition to, executing the function or the service, may request the one or more external electronic devices to perform at least part of the function or the service.

The one or more external electronic devices receiving the request may perform the at least part of the function or the service requested, or an additional function or an additional service related to the request and transfer an outcome of the performing to the electronic device 401. The electronic device 401 may provide the outcome, with or without further processing of the outcome, as at least part of a reply to the request. To that end, a cloud computing, distributed computing, or client-server computing technology may be used, for example.

The electronic device 401 (and, in some embodiments, the electronic devices 402 and 404 or the server 408) may correspond to the server 110 or the client devices 120-1, 120-2, 120-3 described above with reference to FIGS. 1-3. For example, when the electronic device 401 operates as a client device in a federated learning system, the processor 420, memory 430, and communication module 490 may implement the local training module, update computing module, local data storage, and communication interface described for the client devices in FIG. 1 and the operations of FIGS. 2 and 3 (e.g., performing local fine-tuning steps, computing update information, and transmitting the update information to the server). In other embodiments, the server 408 may implement the server 110 of FIG. 1, such that the processor 420 and memory 430 of the server 408 execute instructions to maintain the global model, select participating client devices, aggregate update information, and update the global model as described with respect to FIGS. 2 and 3.

Thus, any of the processors and associated hardware shown in FIG. 4, including the main processor 421, auxiliary processor 423, memory 430 (e.g., volatile memory 432 and non-volatile memory 434), communication module 490, and antenna module 497, may provide the hardware platform for performing the methods described herein. In one example, the instructions for executing the federated learning or meta-learning procedures of FIGS. 2 and 3 are stored in the program 440 of memory 430 and executed by the processor 420 of a client device (e.g., electronic device 401, 402, or 404), while corresponding server-side instructions are stored and executed by the processor 420 of the server 408. In other examples, dedicated hardware accelerators, such as a GPU or other auxiliary processor 423, may implement portions of the model training and update computations, while the remaining components of FIG. 4 provide communication, storage, and user-interface functions.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method of federated learning performed by a server and a plurality of client devices, the method comprising:
receiving, at each client device, a global model comprising a set of model parameters maintained by the server;
performing, at each client device, a plurality of local fine-tuning steps on the global model using local training data of the client device to generate a personalized model for the client device;
computing, at each client device, update information based on the personalized model after the plurality of local fine-tuning steps;
transmitting, from each client device to the server, the update information; and
updating, at the server, the global model based on the update information received from the client devices,
wherein the updating is based at least in part on a loss of the personalized models evaluated after the plurality of local fine-tuning steps.

2. The method of claim 1, wherein the plurality of local fine-tuning steps comprises at least two sequential gradient-based updates applied by each client device.

3. The method of claim 1, wherein the update information computed at each client device comprises a gradient of the loss of the personalized model with respect to the global model or a difference between the personalized model and the global model.

4. The method of claim 1, wherein updating the global model at the server comprises aggregating the update information from the client devices using a weighted average based on a quantity of the local training data of each client device or the loss of the personalized model of each client device.

5. The method of claim 1, wherein the plurality of local fine-tuning steps performed at the client devices uses non-identically distributed local training data across the plurality of client devices.

6. The method of claim 1, wherein the loss of the personalized models evaluated after the plurality of local fine-tuning steps is used to define an objective function minimized by the server when updating the global model.

7. The method of claim 1, wherein the plurality of local fine-tuning steps comprises a predetermined number K of fine-tuning steps selected based on a computation capability of each client device or a communication latency constraint.

8. The method of claim 1, wherein the updating at the server is performed after each communication round comprising distributing the global model to the client devices and receiving the update information from the client devices.

9. A method of federated learning performed by a server and a plurality of client devices, the method comprising:
receiving, at each client device, a global model comprising a set of model parameters maintained by the server;
performing, at each client device, a plurality of local fine-tuning steps on the global model using local training data of the client device to generate a personalized model for the client device;
computing, at each client device, update information based on the personalized model using a first-order approximation that avoids computation of second-order derivatives;
transmitting, from each client device to the server, the update information; and
updating, at the server, the global model based on the update information received from the client devices,
wherein the update information is computed using a Hessian-free approximation of a meta-gradient associated with the personalized model after the plurality of local fine-tuning steps.

10. The method of claim 9, wherein the first-order approximation comprises computing the update information using only gradient information of the personalized model without computing a Hessian matrix or a Hessian-vector product.

11. The method of claim 9, wherein computing the update information comprises applying a truncated gradient update that approximates a meta-gradient associated with the personalized model.

12. The method of claim 9, wherein computing the update information comprises applying an update rule that replaces a second-order dependency with a first-order term derived from the plurality of local fine-tuning steps.

13. The method of claim 9, wherein the update information comprises an approximation of a meta-gradient obtained using gradients from one or more of the local fine-tuning steps.

14. The method of claim 9, wherein computing the update information comprises combining gradients from the plurality of local fine-tuning steps using fixed or adaptive coefficients that approximate a multi-step meta-update.

15. The method of claim 9, wherein the first-order approximation reduces computational complexity of computing the update information relative to a computation involving second-order derivatives.

16. A system comprising:
a server configured to maintain a global model comprising a set of model parameters; and
a plurality of client devices, each client device configured to:
receive the global model from the server;
perform a plurality of local fine-tuning steps on the global model using local training data of the client device to generate a personalized model; and
compute update information based on the personalized model after the plurality of local fine-tuning steps,
wherein the plurality of client devices are further configured to transmit the update information to the server, and
wherein the server is further configured to update the global model based on the update information received from the plurality of client devices, the updating being based at least in part on a loss of the personalized models evaluated after the plurality of local fine-tuning steps.

17. The system of claim 16, wherein each client device is further configured to compute the update information using a first-order approximation that avoids computation of second-order derivatives.

18. The system of claim 16, wherein the server is further configured to aggregate the update information from the plurality of client devices using a weighted average based on a quantity of the local training data of each client device or a loss of the personalized model of each client device.

19. The system of claim 16, wherein each client device is further configured to perform the plurality of local fine-tuning steps using non-identically distributed local training data across the plurality of client devices.

20. The system of claim 16, wherein the server is further configured to update the global model after each communication round comprising distributing the global model to the plurality of client devices and receiving the update information from the plurality of client devices.
